(19) United States
(12) Patent Application Publication
(10) Pub. No.: US 2004/0238568 A1
(43) Pub. Date: Dec. 2, 2004

(54) Valve assembly for containers

(76) Inventor: Michael Ronald Brimson, Nottinghamshire (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/487,856

(22) PCT Filed: Aug. 23, 2002
(86) PCT No.: PCT/GB02/03870

(51) Int. Cl. B67D 5/378

(52) U.S. Cl. 222/153.07

(57) ABSTRACT

A valve member for a container comprising a generally cylindrical passage member (10) having a flange (11) for attachment to the wall of a container surrounding an aperature (13) in the wall of the container through which the passage member (10) extends including a disc-shaped valve member (20) having a domed surface presenting a convex surface to the interior of the container. The value member (20) may be of the form of a disc offset with respect to an axis of rotation thereof. The valve member (20) may be provided with an overmoulded scaling member (125). A temper evident diaphragm (15) may be frangibly connected to an end of the passage member (20) in order to indicate whether the container has been opened.

This invention relates to valve assemblies for containers, particularly to valves usually of plastics material, for use with disposable liner bags for containers. Such valves are preferably fabricated as cheaply as possible as they are usually disposed of with the liner bag, and the liner bags may typically contain up to or over 1000 litres of liquid goods.

A known form of valve for this use is attached or attachable to the wall of the bag, and includes a circular blade which is pushed into the wall of the bag to cut out a circular aperture in the manner of a pastry cutter, thus creating an outlet from the bag, which is previously sealed to be controlled by operation of the valve. See for example U.S. Pat. No. 5,482,176 and WO99/51504.

It is also known to provide valves which are built into the bag, with the edges of a preformed aperture in the wall being sealed to the valve housing, and the bag being sealed by the valve apparatus only.

In either ease, it may not be apparent whether the valve has been operated to break the bag wall, or to allow some of the contents of the bag to be drawn off. Equally, inlet caps closed after filling of the container may not show whether they have been re-opened, for example with the risk of deliberate or accidental contamination of the contents of the container.

Containers having a closure from which it is evident that the closure has or has not been opened or tampered with prior to first authorised opening of the container are known for example from U.S. Pat. No. 5,456,374 where a closure cap for a valve has a detachable ring connected to the main part of the cap by frangible connections so that twisting of the cap to open the same will sever the connections leaving the ring separate from the cap.

The valve member in such a simple disposable valve may be a simple rotatable disk or butterfly valve, mounted on a spindle which is rotatably mounted in a spigot or neck. This form of valve however, once the end cap has been opened may not provide complete sealing of the spigot between using the valve to draw off material from the container.

It is an object of the invention to provide a more effective type of valve closure which is nevertheless still low cost, to maintain sealing closure of the container after first opening of the valve closure and between uses of the valve.

According to the invention a valve assembly for a container comprises a generally cylindrical passage member having a flange for attachment to the wall of a container surrounding an aperture in the wall of the container through which the passage member extends including a disc-shaped valve member having a domed surface presenting a convex surface to the interior of the container.

The valve member is preferably off-set with respect to an axis of rotation thereof defined by trunnion bearings in the passage member. One such bearing may be a stab shaft carried in an arm integrally formed with the valve member and received in a blind bore or recess in the wall of the passage member.

Another bearing may comprise a shaft which extends outwardly through the wall of the passage member at a point diametrically opposed to the stub shaft and the protruding end can be engaged by an appropriately keyed lever for engaging key means, such as a specific geometric shape or splines or studs, provided on the protruding end of the shaft. The shaft may be formed separately from the valve member and engage therewith by means of an appropriately shaped or keyed end engaging in a corresponding shaped or keyed aperture in the valve member structure.

The passage member may be provided with a recess adapted to receive a protrusion or tab provided on the valve member, or the tab may be provided on the passage member with a recess in the valve member. The engagement of the tab within the recess limits the movement of the valve member, preventing it from completely rotating past a predefined limit.

The valve member may have an upper or outer surface which is concave and defines a raised rim which cooperates with a valve seat defined by the passage member. The valve member may also be provided with a sealing member to reduce passage of the contents of the container passage the valve member in use of the valve assembly in a closed position. The sea member may be formed about the outer surface of the valve member. The sealing member may be an o-ring held in a circumferential recess in the valve member. Alternatively, the sealing member may be an overmoulding of sealing material circumferentially about the valve member. This overmoulding may comprise an injection moulding and may comprise rubber or any substance suitably resistant to the intended contents of the container.

Furthermore, a spindle sealing member may be provided, which seals the passages through which the shaft passes through the passage member. This may be of the form of an overmoulding, typically an injection moulding, which may be of rubber or any suitably resistant material.

The passage member may have an outer end which is closed by a tamper-evident diaphragm closure. This can extend across the outer end and preferably has a frangible connection to the rim of the outer end, and may have a pull tab for opening the closure diaphragm. The pull tab may be recessed into the surface of the diaphragm and may be removable to enable a hole to be punched manually through the thinner diaphragm part exposed thereby, to obtain leverage to open the diaphragm, or may itself provide leverage for pulling open of the diaphragm.

The accompany drawings illustrate a preferred embodiment of the invention, which is described by way of example only.

In the drawings:

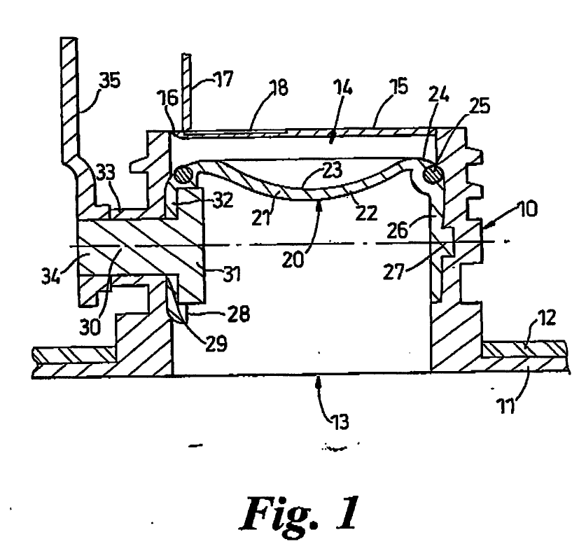

FIG. 1 is a sectional view of a valve assembly according to the invention;

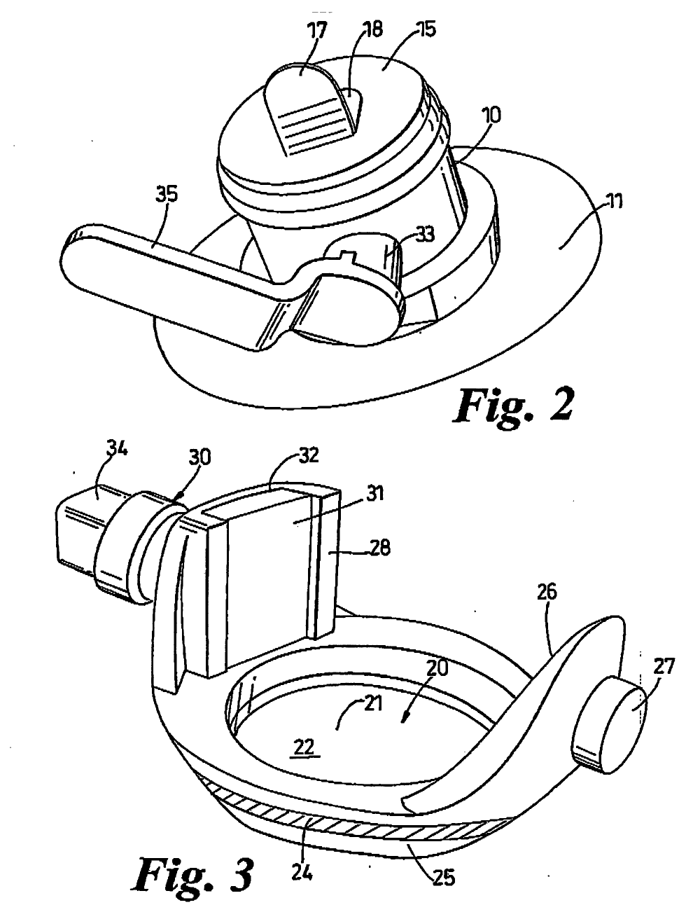

FIG. 2 is an external perspective view of the valve assembly of FIG. 1;

FIG. 3 is a perspective view of a valve member used in the valve assembly of FIGS. 1 and 2;

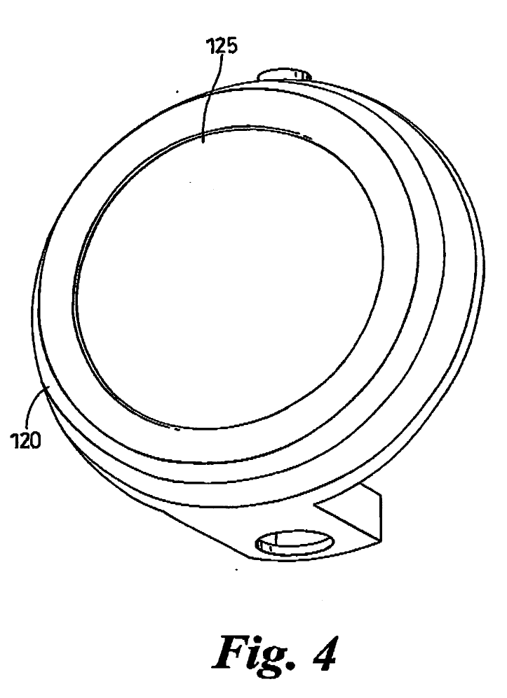

FIG. 4 is an external perspective view of an alternative valve member used in a valve assembly according to the invention; and

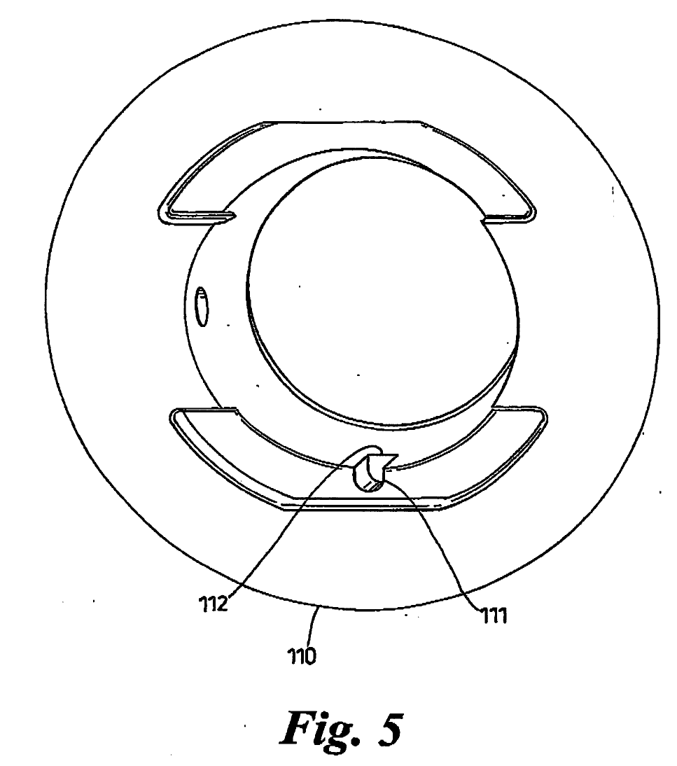

FIG. 5 is an external perspective view of an alternative passage member according to the present invention.

The valve assembly of the invention shown in the drawings comprises a generally cylindrical passage member 10 which has a base flange 11 which can be engaged with the walls of a container from inside the container, with the cylindrical part of the passage member 10 extending out from an aperture 13 in the container wall.

The passage member 10 has an open end 14 which is closed by a removable diaphragm 15, connected to the rim of the open end 14 by a frangible connection 16. A pull tab 17 is provided which is normally laid flat in recess 18 but can be lifted to the position shown by engagement with fingers, and then pulled to break the connection 16 and enable removal of the diaphragm 15. The diaphragm 15 must be removed before material such as liquid can be dispensed through the valve, and provides a tamper-evident closure which will show whether there has been any attempt to open the valve and remove material from the container.

The valve assembly also comprises a valve member 20 which is in the form of an axially eccentric disc or butterfly valve. The valve member 20 comprises a valve disc 21 which presents a convex domed surface 22 inwardly towards the container, and a recessed surface 23 outwardly, and thus provides a raised rim 24 which engages with a curved valve seat provided in the walls of the passage member 10, with a seal ring 25 in the rim 24 of the disc 21.

The valve member 20 also comprises a lug 26 with a stub shaft trunnion bearing 27 which engages in a corresponding recess in the passage member wall. A second lug 28 is provided diametrically opposite lug 26, which has an aperture 29 for a shaft 30 which has a square head 31 which fits in a recess 32 in the lug 28. Shaft 30 extends out through the wall: of the passage member via a cylindrical bearing 33, and has an end 34 which is suitably keyed to engage a removable operating handle 35. This latter feature ensures that the valve can only be conveniently operated with a correctly keyed handle 35, thereby increasing security of the contents. Keying may be achieved by means of variations in the number a proportion of facets, or the arrangement of splines and studs.

The parts of the valve assembly are all moulded from suitable plastics materials, including the shafts and bearings which may for example be of polyamide coated with a fluorocarbon material to be self lubricating.

The valve assembly allows an increase in the security of the container closure, which is tamper evident whilst still retaining the advantages of cheap manufacture to enable the assembly to be used with disposable containers such as tank lining bags.

An alternative valve member 120 is shown in FIG. 4 of the accompanying drawings. It is identical to that of FIGS. 1 to 3 of the accompanying drawings except for the provision of an overmoulding 125 replacing the seal ring 25 of FIGS. 1 to 3. This overmoulding 125 is of the form of an injection moulding circumferentially around the edge of the valve member 120. It is envisaged that the overmoulding 125 would be of rubber, but may also be of any suitable material chosen with regards to the nature of the material to be stored within the container.

An alternative passage member 110 is shown in FIG. 5 of the accompanying drawings. This is substantially the same as the passage member 10 of the embodiment of FIGS. 1 to 3 of the accompanying drawings except for provision of a recess 111 in the wall of the passage member, circumferentially half way between the recesses for the shafts of die valve members. The recess is of semi-circular cross section and extends partway along the length of the passage member terminating with a stop wall 112. A corresponding tab (not shown) on the valve member positioned to cooperate with the recess 111 such that the stop wall 112 prevents passage of the tab past a point. Accordingly, rotation of the valve member is stopped at a point defined by the stop wall 112, which provides for a repeatable sealing position.

1. A valve assembly for a container comprising a generally cylindrical passage member having a flange for attachment to the wall of a container surrounding an aperture in the wall of the container through which the passage member extends including a disk-shaped valve member having a domed surface presenting a convex surface to the interior of the container.

2. A valve assembly according to claim 1 in which the valve member is off-set with respect to an axis of rotation thereof defined by trunnion bearings in the passage member.

3. A valve assembly according to claim 2 in which one of the trunnion bearings is a stub shaft carried in an arm integrally formed with the valve member and received in a blind bore or recess in the wall of the passage member.

4. A valve assembly of claim 3 in which one other of the trunnion bearings comprises a shaft which extends outwardly through the wall of the passage member at a point diametrically opposed to the stub shaft and the protruding end can be engaged by an appropriately keyed lever of engaging key means provided on the protruding end of the shaft.

5. The valve assembly of claim 4 in which the shaft is formed separately from the valve member and engages therewith by means of an appropriately shaped or keyed end engaging in a corresponding shaped or keyed aperture in the valve member structure.

6. A valve assembly according to any proceeding claim 1 in which the passage member is provided with a recess adapted to receive a protrusion or tab provided on the valve member, or the tab may be provided on the passage member with a recess in the valve member.

7. A valve assembly according to claim 1 in which the valve member is provided with a sealing member to reduce passage of the contents of the container in use of the valve assembly in a closed position.

8. A valve assembly according to claim 7 in which the sealing member is an o-ring held in a circumferential recess in the valve member.

9. A valve assembly according to claim 7 in which the sealing device is an overmoulding of sealing material circumferentially about the valve member.

10. A valve assembly according to claim 9 in which the overmoulding is an injection moulding.

11. A valve assembly according to claim 9 or claim 10 in which the sealing material is rubber.

12. A valve assembly according to claim 4, in which a spindle sealing member is provided, which seals the passage through which the shaft passes through the passage member.

13. A valve assembly according to claim 12 in which the spindle sealing member is an overmoulding.

14. The valve assembly of claim 1 in which the passage member has an outer end which is closed by a tamper-evident diaphragm closure.

15. The valve assembly of claim 14 in which the closure diaphragm extends across the outer end and has a frangible connection to the rim of the outer end.

16. The valve assembly of claim 15 in which the closure diaphragm has a pull tab for opening the closure diaphragm.

17. The valve assembly of claim 16 in which the pull tab is recessed into the surface of the diaphragm and may be removable to enable a hole to be punched manually through a thinner diaphragm part exposed thereby, to obtain leverage to open the diaphragm.

18. A valve assembly according to claim 16 in which the pull tab itself provides leverage for pulling open of the diaphragm.
